(19) United States
(12) Patent Application Publication
(10) Pub. No.: US 2004/0155565 A1
(43) Pub. Date: Aug. 12, 2004

(54) Method and apparatus for the efficient collection and distribution of light for illumination

(76) Inventors: Ronald G. Holder, Laguna Niguel, CA (US); Greg Rhoads, Irvine, CA (US)

Correspondence Address: Daniel L. Dawes, MYERS, DAWES & ANDRAS LLP, Ste 1150, 19900 MacArthur Blvd, Irvine, CA, 92612, US

(21) Appl. No.: 10/361,137

(22) Filed: Feb. 6, 2003

(51) Int. Cl. H01J 5/16

(52) U.S. Cl. 313/113

(57) ABSTRACT

The emitter within LED lamp(s) radiates light over of solid angle of approximately 2π steradians or an approximate hemisphere. Conventionally, some of the light emitted is directly transmitted to the object to be illuminated and another portion is indirectly transmitted by means of a reflector, refractive optic or both. The disclosed method increases the collection efficiency of the radiated energy from LED lamp(s) by turning the LED or other light source so that all of its transmitted light is directed away from the object of the apparatus and directed into a reflector. The reflector then reflects the light toward the object. This singular handling of all the energy from the emitter results in more precise control of the radiated energy of the source. Optional subsequent controlling elements may be utilized efficiently due to the fact that the rays they will affect are of a single class of rays.

### BACKGROUND OF THE INVENTION

1. Field of the Invention

The invention relates to the capture and control of the light emanating from light emitting diodes and other illumination devices and more particularly to improving the efficiency of systems using such devices.

2. Description of the Prior Art

Within the category of general illumination is a subcategory of systems designed to modify some aspect of light emanating from a light source. For illumination systems that fall in this category, control of the illumination is critical. Several examples of products incorporating these systems are flashlights, automotive, task, industrial and decorative lighting.

An illumination apparatus for this category of systems is comprised of two main components; at least one source element and at least one modifying element. The modifying element(s) are most often either refractive or reflective or a combination of the two.

A light source can be characterized by the light rays that emanate from it. Theoretically, a ‘point’ would be the ideal source in illumination systems. The larger the source, the more difficult it is to focus or control the light emanating from it. Because the source of light in an LED, incandescent or plasma is never a singular point, the output of systems using these devices is never ‘ideal’.

Typical illumination systems use conventional optical surfaces to modify the light emanating from the source. These optical surfaces are generally but not confined to surfaces of revolution and may be conics, aconics, aspheres or not mathematical in nature at all, but constructed of point developments and/or computer generated surfaces.

In order to discuss the impact of proper application of modifiers to an illumination system, we will introduce a concept of classes of light rays. Here the use of the term ‘ray’ is a convenient method to assist in understanding light energy as it propagates through a system. Class 1 rays are those emanating from the source directly. Class 2 and higher numbered classes of rays are defined as those that have been altered in angle and/or intensity by one or more modifier.

For maximum control and efficiency it is advantageous to have a modifier control only one class of rays at a time.

The body of prior art describes various applications of reflective, refractive and combined methods to control the light emanating from a source. Additionally these methods sometimes utilize a portion of the direct light emitted by the source itself.

Sources of light, such as an LED emitter, do not radiate light in a spherical pattern (4 pi steradians). There are additional factors such as leads, heat sink and mounting considerations that block some portion of the radiated energy from the source in an illumination system. FIG. 1 shows light emanating from an LED emitter mounted on a surface or base. FIG. 1 further shows the rays and their preferred direction 18 that is usually the central ray emanating from the source. Most LEDs have a preferred direction that is substantially normal to the emitter surface and all the rays 14 fill a solid angle 32 of about +/−90-100 degrees (˜2π steradians). The opposite direction 30, or non-preferred direction contains substantially no collectable energy. This direction is typically used for device leads and mounting.

A conventionally packaged light-emitting element 12 of a light-emitting diode is mounted on a lead frame 28 and has a light-transparent resin molded around it for protection and to form a lens portion 34 as shown in FIG. 2. There are several standard forms of this package 10a intended for general-purpose small lighting applications. Pugh, “Encapsulated Light Emitting Diode And Method For Encapsulation,” U.S. Pat. No. 5,122,943 (1992) shows a light pattern generated by this general-purpose package creates a virtual source that is quite large and has a very non-uniform radiation pattern. A light emitting diode with reduced stray light includes a base with an active light emitting element mounted in the base. An epoxy envelope is mounted on the base. The envelope includes a conical side portion and a spherical dome portion. The envelope is encapsulated with optically absorbing material of low reflectivity. The optically absorbing material is in direct contact with the side portion of the envelope and part of the spherical dome portion leaving an exposed portion through which rays of light pass. Although these standard package types are useful for their intended small lighting applications, this light pattern is very difficult to control.

As illustrated in FIG. 3, the light rays emanate from the active light emitting surface 25, strike the various optical surfaces, and are refracted by the epoxy resin envelope 38. In this package type, the rays emitted from the active light emitting surface 25 can be grouped into four classes.

Class 1 Rays 14 are the rays emanating from the emitter or source. Class 2 rays 58 are refracted by the spherical dome portion 34 of the epoxy resin envelope 38. Class 2 rays make up about 29% of the total rays, and conventionally are considered to comprise the most useful rays since they remain generally collimated at some distance from the LED 10a.

Class 3 rays 62 are refracted by the spherical dome portion 34 of the epoxy resin envelope 38 after first being internally reflected by the side portion 17 of the epoxy resin envelope 38. Class 3 rays make up about 19% of the total rays. Class 3 rays are not conventionally regarded as useful as they form a ring of light which diverges widely upon leaving the LED 10a.

Class 4 rays 42 pass through and are refracted by the side portion 17 of the epoxy resin envelope 38. Class 4 rays make up about 28% of the total rays, and are not conventionally regarded as useful as they also form a wide diverging background upon leaving the LED 10a.

Class 5 rays 60 are internally reflected by the epoxy resin envelope 34,38 and make up the remaining 24% of the total number of rays. As with class 3 and 4 rays, class 5 rays are not conventionally regarded as useful since they exit the back of the LED 10a.

Some of the various approaches of the prior art are directed to providing some kind of additional structures to specifically deal with one or more of these classes of rays.

For example, one technique of the prior art uses a lens to image the source at a distance.

For example, another technique of the prior art creates a new virtual source, such as shown in Mize, “Illuminating Apparatus And Light Emitting Diode”, U.S. Pat. No. 6,328,456 (2001).

Mize shows an LED lamp and method of using one or more lamps in portable lighting products such as flashlights using such LED lamp(s). The LED lamp provides uniformly distributed light that radiates spherically approximately 270° in all directions, both radially and axially. The lamp is combined with a reflective surface to produce a beam of light. The chip is encased in at least one envelope with the envelope extending from a first position below the position of the chip to a second position above the chip position. The second position of the envelope forms a lens in front of the chip with the surface of the lens being configured and positioned relative to the chip such that light emitted from the chip is reflected off of the surface. In this manner, light is radiated spherically over an angle up to 270° relative to the chip position.

In one embodiment, the dome of the LED package is machined and left in an abraded or frosted condition to create a bright source of scattered light. This creates an enlarged light emitting surface which makes focusing by means of reflection even more difficult and the method still does not remove all the classes of rays. The different classes remain and must each be optically treated in a different manner which is often impossible or only partially successful.

A third prior art technique is to create a new lens and/or reflector structure around the existing envelope. For example, McDermott, “Elliptical Axial Lighting Device,” U.S. Pat. No. 5,894,195 (1999) seeks to separately optically treat certain classes of the rays by including a light concentrating reflector directing light emitted by a light source towards a curved light refracting surface where it is refracted and redirected. The light reflecting surface is contoured to direct the reflected light to converge towards one or more points and to additionally converge towards a reference axis. The light refracting surface is contoured and positioned to cooperate with the contour of the light concentrating reflector such that after passing through the refracting surface the emerging light forms a light beam concentrated about the reference axis. An optional light refracting lens is included in a further attempt to deal with different classes of rays by redirecting forward light emitted by the light source to further increase the intensity of the concentrated light beam.

### BRIEF SUMMARY OF THE INVENTION

The present invention relates in the illustrated embodiment to a light emitting diode (LED), and a method for maximizing the collection efficiency and facilitating control of the radiated energy.

In particular, the invention is an apparatus comprising a source of light characterized by emitted light rays, and a light reflector. The source of light is oriented with its preferred direction toward the reflector so that substantially all the light rays are reflected by the reflector and manipulated as substantially a single class of light rays. The source of light has a base or package through which little light is propagated with light generally propagating away from the source in directions not directed into the base of the source, and wherein the base of the source is directed away from the reflector. The reflector collects substantially all of the light rays and directs them toward a predetermined direction of illumination. In one embodiment the reflector tends to collimate the collected light and direct it toward the predetermined direction of illumination.

In one illustrated embodiment the source of light is a light emitting diode, which may be packaged in a transparent body, shaped and polished to negate the effect of its outer surface to act as a lens, thus allowing the emitter to naturally emit rays within substantially 2π steradians of a preferred axis normal to the emitter.

In one embodiment the means for orienting the light emitting diode is a mechanical mount that holds the packaged light emitting diode the so that the forward direction is turned back into the reflector. The mount may in fact simply be the leads to the LED itself. The reflector collects substantially all of the light emitted from the light emitting diode and directs the collected light in a predetermined direction as a single class of rays.

In another embodiment, there is space defined between the body of the light emitting diode and the reflector. The body of the light emitting diode is potted or molded into a transparent material with an approximately matching index of refraction to the LED package filling the space between the light emitting diode and the reflector back into the reflector collects substantially all of the light from the light surface and directs them in at least one predetermined direction.

One advantage of the invention is that all the rays reflected by the reflector can have substantially the same angle or an even distribution of angles so that, optionally, they could be efficiently modified by one or more elements between the reflector and the object of the system.

In one embodiment the means for orienting the source of light with respect to the reflector comprises a mechanical fixture attached to the light emitting diode. In another embodiment the means for orienting the source of light with respect to the reflector comprises a transparent material disposed between the reflector and the light emitting diode. In the latter embodiment there is a defined space between the reflector and the light surface of the light emitting diode, and where the transparent material disposed between the reflector and the light emitting diode completely fills the space between the light surface and the reflector. In one embodiment the transparent material has a defined surface and where the reflector is a specular layer on the defined surface to comprise the reflector. In addition to an LED, the source of light may comprise an incandescent light source, a plasma light source, or a fluorescent light source.

Still further the invention is defined as an apparatus comprising an LED emitter with a near hemispherical emitted ray pattern having a defined forward direction, and a reflective surface facing the LED emitter, which reflective surface reflects the energy from the emitter back in an approximately opposite direction from the LED emitter's forward direction. The reflective surface may be a surface of revolution with conic or aconic cross-section, or a surface, which shapes the reflecting energy via non-analytically defined points, such as facets or nonuniform cross sections. The reflective surface comprises a surface, which is either uniformly or randomly disturbed with facets, bumps or other surface disturbances to provide integration of the energy.

The apparatus further comprises an optical surface and where the energy reflected from the reflective surface is then refracted through the optical surface which may be conical, spherical, aconic or any other optically refracting shape. The surface may also be a Fresnel element.

The LED emitter is provided as a premanufactured LED package with a lens portion and where the reflector surface is provided as a separate reflector. The lens portion is modified by machining a spherical surface on the lens portion with its spherical center approximately at the center of the LED emitter.

In one embodiment the reflective surface comprises a reflector body on which a specular surface is provided and where the LED emitter further comprises a premanufactured LED package which has been immersed in an index matching, or near index matching material by either molding around the premanufactured LED package filling a space between the reflector body and premanufactured LED package, or by potting it into a premolded recess defined in a reflector body for receiving the premanufactured LED package.

The LED emitter, reflective surface and mount may also incorporate a receiver or other means to attach a fiber optic cable that provides an efficient coupling of the emitter and fiber optic.

The LED emitter, reflective surface and optical surface are each separate from each other, and are glued, potted, bonded, molded or assembled into a single unit.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a schematic illustration of the emitter of a light emitting diode (LED) which shows the pattern of rays emanating from it.

FIG. 2 is a diagrammatic side cross-sectional view of a prior art packaged light emitting diode (LED).

FIG. 3 is a schematic illustration of the light emitting diode of FIG. 2 which shows the paths of different classes of rays of light.

FIG. 4a is a graph of intensity verses angle of the illumination pattern of the emitter of a common LED.

FIG. 4b is a graph of intensity verses angle of the illumination pattern of the prior art of packaged LED of FIGS. 2 and 3 showing the results of the contribution of different classes of rays.

FIG. 4c is the graph of intensity verses angle of illumination pattern of the invention showing the substantially fully controlled result of its implementation.

FIG. 5 is a diagrammatic side cross-sectional view of one preferred embodiment of the invention where an emitter is oriented with its preferred direction facing away from the object of the system and toward a reflector that is reflecting substantially all of the emitter's light rays toward the object.

FIG. 6 is a diagrammatic side cross-sectional view of another embodiment of the invention where an LED emitter is a common LED oriented with its preferred direction facing toward a reflector, potted in an index matching material to remove the refracted effects of the molded lens on the emitted light of the emitter.

FIG. 7 is a diagrammatic side cross-sectional view of yet another embodiment where the LED is separately mounted with the emitter oriented with its preferred direction facing toward a reflector and the surface of the LED package is either manufactured with a half-dome with its center at the center of the emitter, or it is remanufactured as such.

FIG. 8a is a diagrammatic side cross-sectional view of yet another embodiment where the apparatus of FIG. 5 is further modified to include a lens on the output surface.

FIG. 8b is a diagrammatic side cross-sectional view of yet another embodiment where the apparatus of FIG. 8a is further modified where the lens on the output surface is a Fresnel.

FIG. 9 is a diagrammatic side cross-sectional view of yet another embodiment where the apparatus has been optimized as a fiber-optic light engine where the output of the emitter is directed by the reflector into a fiber-optic cable, preferably matching the numerical aperture of the fiber.

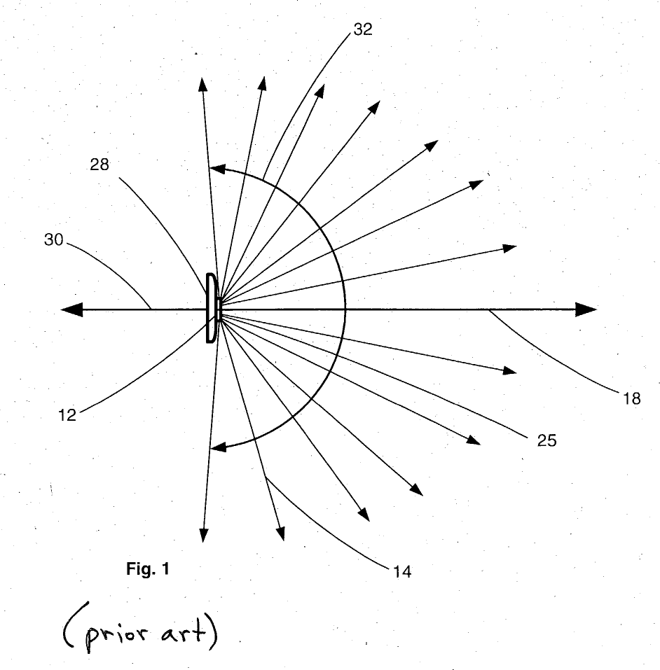

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

While the invention can be demonstrated to work with almost any traditional light source, The discussions that follow concentrate primarily to its use with LED emitters.

LED's are increasingly being utilized in almost every field of illumination. They have achieved a level of brightness and efficiency that for many uses makes them a better choice than traditional lamps with filaments or arcs. For example, they are used in streetlights, automotive lighting, flashlights, decorative lighting, architectural, general lighting and many other applications.

The light-emitting element within LED lamps radiate light over of solid angle of approximately 2π steradians or an approximate hemisphere. Conventionally, some of the light is directly transmitted to the object to be illuminated and another portion of the light is indirectly transmitted by means of a reflector or other means. The disclosed method increases the collection efficiency of the radiated energy from LED lamps by orienting the LED so that substantially all of its emitted light is directed away from the object of the illumination system and directed backwards toward a reflector. The reflector then collects and reflects the light toward the object. This results in an enhanced ability to control the energy radiating from the light source.

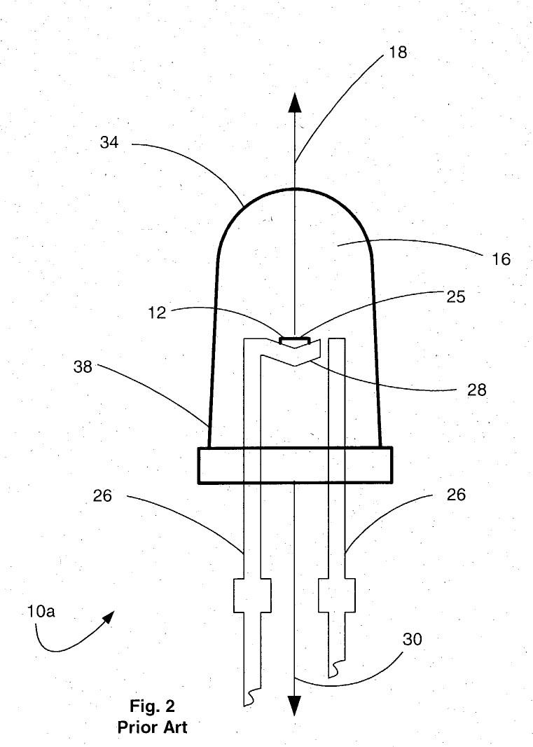

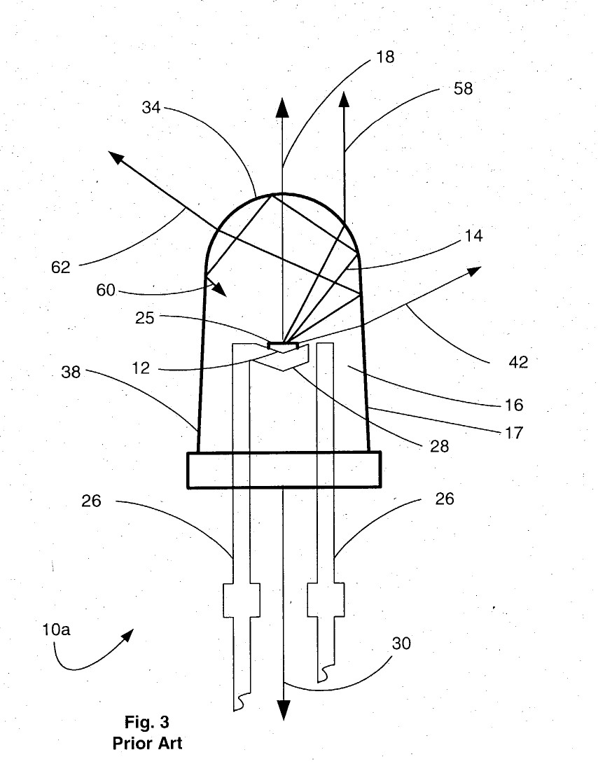

A typical LED, generally denoted by reference numeral 10a as diagrammatically shown in side cross-sectional view in FIG. 2, is comprised of an emitter 12, a means or lead 26 to bring electric current to the emitter 12, and a base 28 to hold the emitter 12 in place. Base 28 can be a carrier designed primarily to hold the emitter 12 in place, or a molded package that engulfs the emitter 12 and leads 26 in an epoxy or other transparent material 16 with or without a lens 34 formed opposite the emitter 12. When a lens 34 is present on part of the envelope 38 it is generally a dome that collects the energy or light from the emitter 12 and collects it into a beam directed along central axis 18.

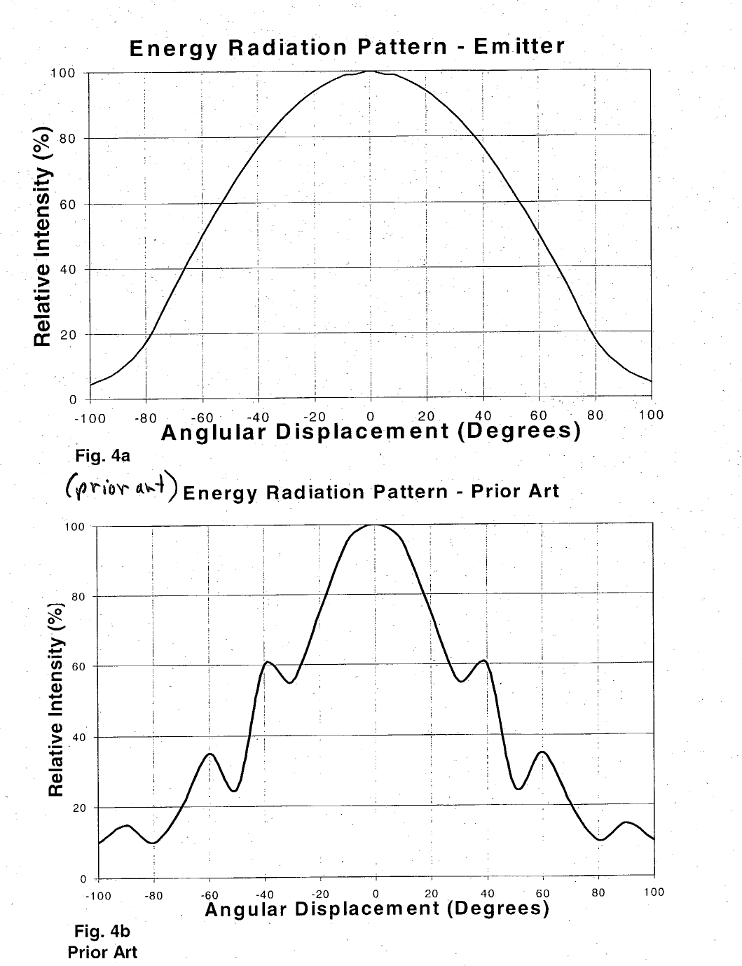

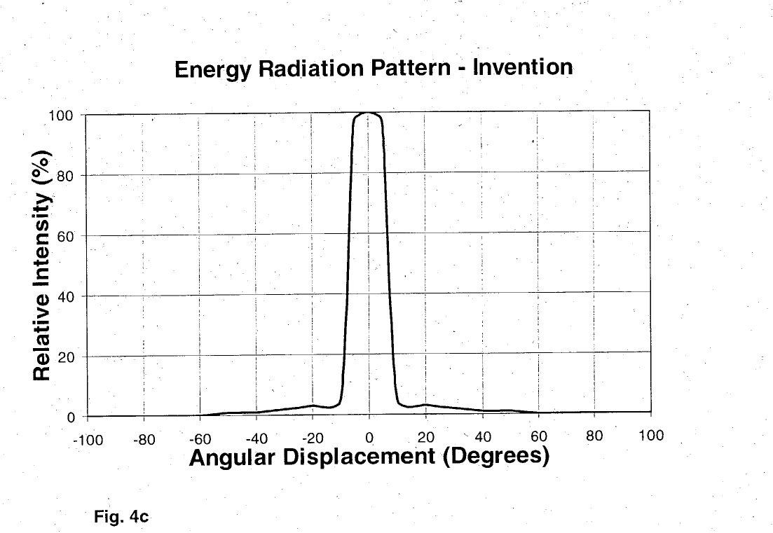

The construction of the actual LED emitter 12 is not materially significant to the invention as the invention will work with most, if not all, types of LED emitters 12 currently in manufacture whether singular or arrays of multiple emitters. FIG. 4a is a graph of light intensity verses angle, which shows the energy pattern that emanates from an LED emitter 12. Most conventionally packaged LED packages in fact have a much more irregular illumination pattern with intensity varying widely by angle as shown in FIG. 4b. The approach of the invention is illustrated in the graph of FIG. 4c, where all light from the system can be optically treated the same. The intensity level of the graphs FIG. 4a, FIG. 4b and FIG. 4c show relative intensity as a percent of the total for that system. Relatively, however, assuming the same emitter in all cases, the intensity of the central ray of the invention will be higher that that of the LED package 10a shown in FIG. 4b, and the total energy received by the object will be higher as well.

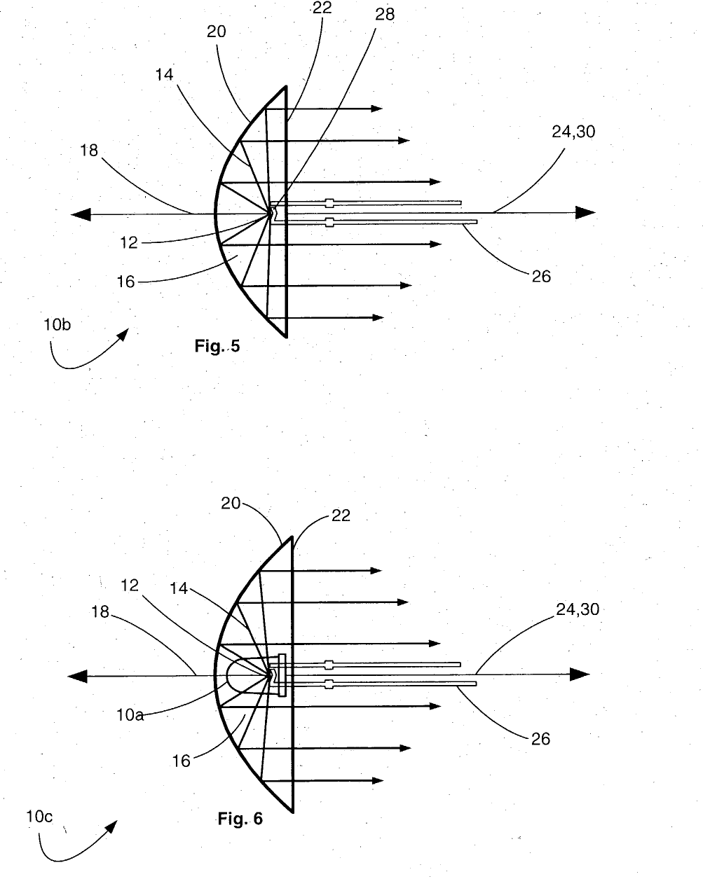

The invention is comprised of two main elements as shown diagrammatically in the side cross-sectional view of FIG. 5. An emitter 12 and a concave reflective surface 20. The emitter 12 has an axis 18 perpendicular to its emitting surface 25. This is its primary axis. The concave surface 20 is situated in the illustrated embodiment to receive substantially all of the energy that emanates from the emitter 12. Other sized envelopes could be substituted as needed according to the light source used.

The LED emitter 12 is now turned backwards as compared to the configuration of FIG. 4b, that is the center forward axis of the LED emitter 12 is directed back into the reflector 20 and is generally coaxial with the optical axis of the reflector 20. In a preferred embodiment the emitter 12 would be manufactured in such a way as to have a base not much larger than the emitter 12. The small portion of emitted light that is interfered with by the emitter packaging or leads can therefor be minimized.

The concave surface 20 is reflective and therefor reflects the energy primarily back along the axis 18 of the emitter 12. Again other optical arrangements could be devised and applied if desired. Based on the surface contour and/or geometric shape of surface 20, the reflected energy can then be controlled in the opposite-direction of axis 18 of emitter 12. In some embodiments of the invention, some of the reflected energy may be interfered with by the emitter 12 itself. In still other embodiments the energy along the axis 18 of the emitter may be diverted for use by an additional controlling surface instead of being obscured by the emitter 12 or its containment device, base 28.

In any case, it can now be appreciated by turning LED emitter 12 backwards and directing all the light rays 14 emitted from it into a reflecting surface 20, that the utilization of the available light for useful illumination of an object forward of the reflector 20 is achieved.

Turn now to two further embodiments of the present invention illustrated below. The light source emitter 12 is very small and very bright, so the first step is to gain access to the actual source of illumination. The stock or factory envelope 38 has to be removed or modified so that it is no longer a factor in the optical environment. The second step is to gather and control the radiated energy in the most efficient manner possible

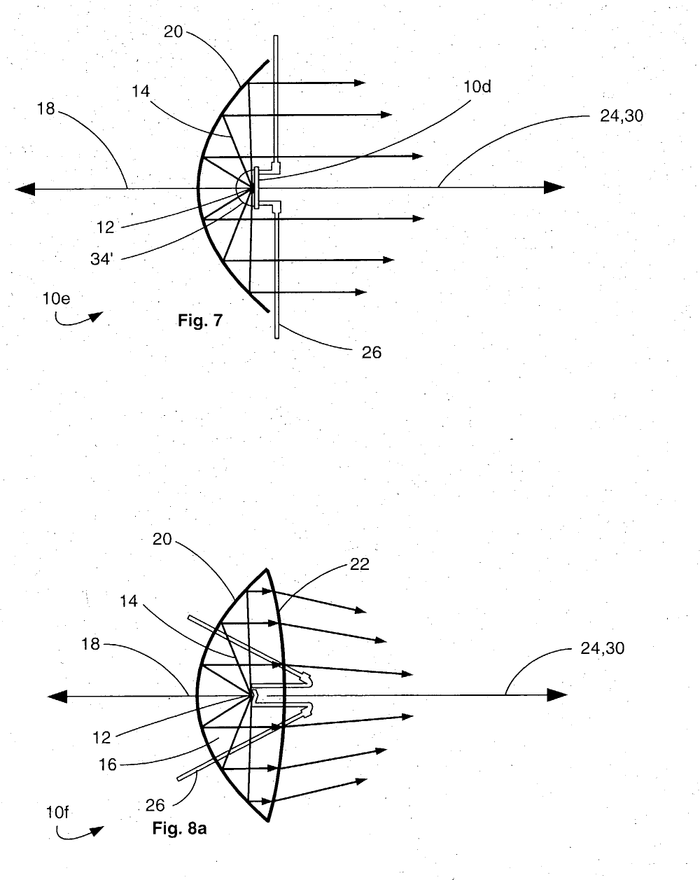

A first approach for eliminating the package or envelope 38 as an optical element in the environment is to recontour the forward portion of dome 34 to create a polished spherical surface 34′ with the source emitter 12 at the center of the sphere as shown in FIG. 7. This will eliminate any optical interference from dome 34. Dome 34 is thus modified by machining away the excess material to render the surface of the packaging spherical as depicted by surface 34′ in FIG. 7. The 'surface is polished to avoid scattering. All rays radiating from the source at surface 25 will strike the surface of the envelope or dome 34′ substantially normal to the surface and therefore not refract in an undesirable direction.

The second approach is to encapsulate the existing package 38 in an index-matching medium 16 such as clear epoxy similar to the material that the stock package 10a is molded from. The device can be encapsulated oversize and then re-contoured to the appropriate shape, or the package 10a can be encapsulated into, for example, the reflector 20 that will be used to shape or control the radiated energy. As shown in FIG. 6 there is a space 16 between LED 10a and reflecting surface 20. This space can be completely filled by a transparent material 16 or resin having a matching or nearly matching index of refraction to the material of packaged LED 10a and dome 34 to eliminate or minimize optical boundaries that may add to the refraction and dispersive scattering of light from emitter 12.

Refractive techniques for controlling or focusing energy radiating from a point source are limited in their efficiency. In the best case about 75 percent of the energy can be collected and controlled using this method. Reflectors as controlling surfaces can be efficient if properly used. When the optical axis 18 of the emitter 12 and a reflector are co-axial and facing in the same direction the output energy will have two classes of light mixed together making it impossible to control the light toward an object efficiently. These classes are the direct illumination from the emitter 12 the indirect reflected illumination from the reflector. The disclosed invention shows the axis 18 of the emitter 12 and reflector 20 co-axial but opposite in direction in which case essentially all the rays 14 are captured and controlled by the reflector 20.

FIG. 5 is a diagrammatic illustration of one embodiment where emitter 12 is suspended on leads 26 facing a reflector 20, but surface 25 of emitter 12 is turned backwards from its conventional orientation as shown in FIG. 2, so that it faces reflector 20 and has its normal generally coaxial with the axis 24 of symmetry of reflector 20. No dome 34 is provided, but emitter 12 may be potted or embedded in a transparent material 16 filling the space or cavity defined by reflector 20.

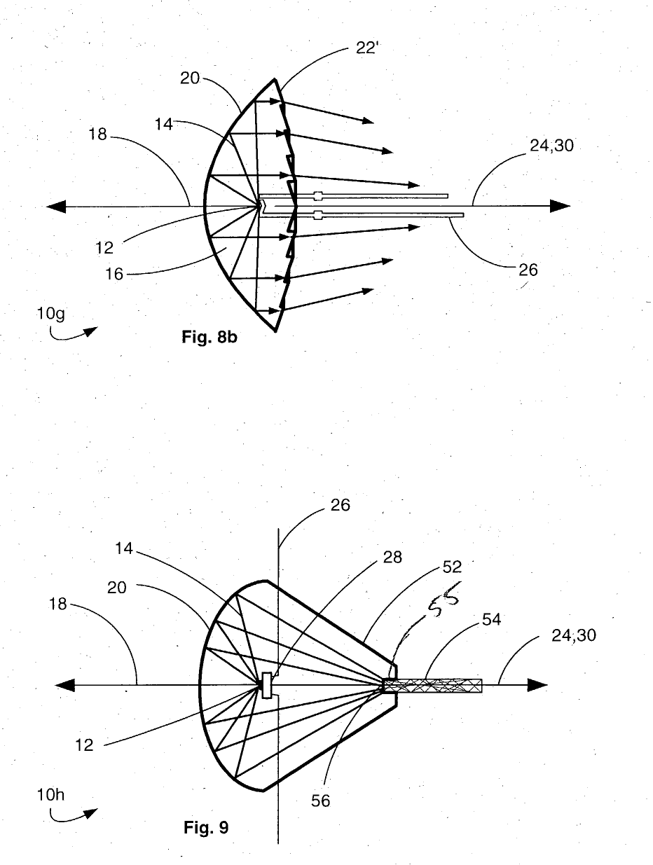

In another embodiment as shown in the diagrammatic side cross-sectional view of FIG. 8a, the surface 22 of material 16 filling reflector 20 and embedding emitter 12 may be contoured or shaped into a lens, which in the embodiment of FIG. 8b is a Fresnel lens 22′. While the illustrated embodiments have been shown as integral units, i.e. an LED emitter 12 embedded in a reflector 20 with a lens 22, it is also within the scope of the invention that LED emitter 12, reflector 20 and optical surface 22 could be manufactured as separate pieces and then affixed together to form a single module.

One of the advantages of the invention is that as schematically depicted in FIG. 9 an LED emitter 12 directed backwards into a reflector 20 can produce a light pattern which can be easily focused with or without a simple lens 22 into the end surface 56 of a fiber optic 54 so that the numerical aperture of the apparatus and optic fiber 54 are matched. Substantially all of the light from an LED emitter 12, which is inherently adapted to high speed electrical modulation, can be efficiently coupled into an optical fiber 54 by use of the invention. FIG. 9 shows an integral optical body in which emitter 28 has been embedded, molded or potted facing reflector 20 which focuses the light from emitter 28 onto end surface 56 of optic fiber 54. Optic fiber 54 can be bonded, molded, potted, or otherwise retained in place into a receiving bore 55 in the transparent optical body 52. Additionally an optical detector (not shown) could be molded, bonded or otherwise incorporated into body 52 at or near the focal point of reflector 20 with emitter 28 to allow the device of FIG. 9 to become an optical transceiver.

The uses which can thus be made of a high efficiency LED light source are too numerous to completely list, but it is contemplated that all of the following applications are achievable. The light source of the invention can be used in any situation where a task light is needed as opposed to general room illumination, such as in small reading lamps for both stationary as well as vehicle or aircraft use, emergency lighting strips in vehicles or aircraft. The light sources of the invention will find utility in transportation as taillights, marker lights, interior task lighting, traffic signals and the like. In the medical industry the light source is advantageously used for fiber optic illumination for endoscopic instruments and portable surgical task lights. In the consumer market, uses in flashlights, high intensity reading lights, decorative lighting and again task lighting will be achievable. In the industrial market, again use as flashlights, equipment, control panel and front lighting, projector devices, and again task lighting.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments-are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. An apparatus comprising:
a source of light emitting light rays with a defined forward direction which is substantially the direction of the center of all rays emanating from the source; and
a light reflector with a defined optical axis and a defined forward direction;
wherein the source of light is oriented toward the reflector so that the light reflected by the reflector is propagated substantially opposite the forward direction of the source and along the forward direction of the reflector.

2. The apparatus of claim 1 where the source of light has a base through which little light is propagated with light generally propagating away from the source in directions not directed into the base of the source, and wherein the base of the source is directed away from the reflector.

3. The apparatus of claim 1 where the reflector collects substantially all of the light and directs it toward a predetermined direction of illumination.

4. The apparatus of claim 3 where the reflector tends to collimate the collected light and direct it toward the predetermined direction of illumination.

5. The apparatus of claim 1 where the source of light is a light emitting diode.

6. The apparatus of claim 5 where the light emitting diode is packaged in a transparent body shaped to provide a lens disposed proximate to the light emitting diode for focusing light from the light emitting diode in a defined direction, and where the light emitting diode is oriented so that the defined direction is turned back into the reflector which collects substantially all of the light emitted from the light emitting diode and directs the collected light in a predetermined direction generally opposite to the defined direction of the light emitting diode.

7. The apparatus of claim 6 where there is space defined between the body of the light emitting diode and the reflector and where the transparent body of the light emitting diode is potted in a transparent material with an at least approximately matching index of refraction filling the space between the light emitting diode and the reflector.

8. The apparatus of claim 5 where the light emitting diode is characterized by a substantially two dimensional area acting as the source of light defined as a light surface, light being emitted from the light surface from only one side of the light surface, the light emitting diode be oriented so that the light surface is directed back into the reflector, the reflector collecting substantially all of the light from the light surface and directing it in at least one predetermined direction.

9. The apparatus of claim 8 further comprising a mechanical fixture attached to the light emitting diode for orienting the source of light with respect to the reflector.

10. The apparatus of claim 8 further comprising a transparent material disposed between the reflector and the light emitting diode for orienting the source of light with respect to the reflector.

11. The apparatus of claim 10 where there is a defined space between the reflector and the light surface of the light emitting diode, and where the transparent material disposed between the reflector and the light emitting diode completely fills the space between the light surface and the reflector.

12. The apparatus of claim 11 where the transparent material has a defined surface and where the reflector is a specular layer on the defined surface to comprise the reflector.

13. The apparatus of claim 1 where the source of light comprises an incandescent light source.

14. The apparatus of claim 1 where the source of light comprises a plasma light source.

15. The apparatus of claim 1 where the source of light comprises a fluorescent light source.

16. A method comprising:
providing light from a source in at least one direction of preferred light propagation defined as a solid light angle while not providing any substantial amount of light in at least one other direction defined as a solid shadow angle;
directing light in the solid light angle to a reflector to be entirely collected;
redirecting substantially all of the collected light from the reflector into at least one predetermined direction; and
directing the solid shadow angle in a direction other than to the reflector so that the reflector collects substantially all of the light emitted by the source.

17. The method of claim 16 where the source of light has a base through which little light is propagated with light generally propagating away from the source in directions not directed into the base of the source, and wherein the base of the source is directed away from the reflector, so that the base defines the solid shadow angle, where directing the solid shadow angle in a direction other than to the reflector comprises orienting the base away from the reflector.

18. The method of claim 16 further comprising collimating the collected light and directing it toward the predetermined direction.

19. The method of claim 16 where providing light from a source comprises providing light from a light emitting diode.

20. The method of claim 16 where there is space defined between the body of the light emitting diode and the reflector and where directing light in the solid light angle to a reflector to be entirely collected comprises potting the transparent body of the light emitting diode in a transparent material with an approximately matching index of refraction filling the space between the light emitting diode and the reflector.

21. The method of claim 16 where the light emitting diode is characterized by a two dimensional area acting as the source of light defined as a light surface, light being emitted from the light surface substantially from only one side of the light surface, where directing light in the solid light angle to a reflector comprises orienting the light emitting diode so that the light surface is directed back into the reflector, the reflector extending to collect substantially all of the light from the light surface.

22. The method of claim 21 where orienting the light emitting diode with respect to the reflector comprises attaching a mechanical fixture to the light emitting diode to fix the orientation back toward the reflector.

23. The method of claim 21 where orienting the light emitting diode with respect to the reflector comprises disposing a transparent material between the reflector and the light emitting diode in which material the light emitting diode is fixed in an orientation directed back to the reflector.

24. The method of claim 23 further comprising providing the transparent material with a defined surface and providing the reflector by disposing a specular layer on the defined surface.

25. The method of claim 16 where providing light from a source comprises providing an incandescent light source.

26. The method of claim 16 where providing light from a source comprises providing a plasma light source.

27. The method of claim 16 where providing light from a source comprises providing a fluorescent light source.

28. A method for illuminating an object in combination with a light collecting reflector comprising:
providing a light source; and
orienting and positioning the light source relative to the reflector to direct to the light toward the collecting reflector which reflects substantially all of the light toward the object.

29. The method of claim 28 further comprising providing the light collecting reflector.

30. The method of claim 28 where the light source also has a substantially unilluminated solid angle into which substantially no light is emitted, and where orienting the light source directs the substantially unilluminated solid angle toward the object to be illuminated.

31. The method of claim 29 further comprising collimating the light and directing it toward the object to be illuminated.

32. The method of claim 29 where there is a defined space between the reflector and the light surface of the light emitting diode, and where orienting and positioning the light source relative to the reflector comprises disposing a transparent material between the reflector and the light emitting diode completely fills the space between the light surface and the reflector.

33. An apparatus comprising:
an LED emitter with emitted ray pattern substantially directed into a hemispherical angle space, the pattern having a defined forward direction; and
a reflective surface facing the forward direction of the LED emitter, which reflective surface reflects the energy from the emitter back in an approximately opposite direction to the LED emitter's forward direction.

34. The apparatus of claim 33 where the reflective surface comprises a surface of revolution with conic or aconic cross-section.

35. The apparatus of claim 33 where the reflective surface comprises a surface, which shapes the reflecting energy via nonanalytically defined points, such as facets or nonuniform cross sections.

36. The apparatus of claim 33 where the reflective surface comprises a surface which is either uniformly or randomly disturbed to provide integration of the energy.

37. The apparatus of claim 33 further comprising an optical surface and where the energy reflected from the reflective surface is, after being reflected, refracted through the optical surface.

38. The apparatus of claim 37 where the optical surface comprises a conical, spherical, aconic, or Fresnel optical surface.

39. The apparatus of claim 33 where the LED emitter is provided as a premanufactured LED package with a lens portion and where the reflector surface is provided as a separate reflector.

40. The apparatus of claim 33 where the LED emitter has a center and further comprises a premanufactured LED package with a lens portion, which has been modified by machining a spherical surface on the lens portion with a spherical center approximately at the center of the LED emitter.

41. The apparatus of claim 33 where the reflective surface comprises a reflector body on which a specular surface is provided and where the LED emitter further comprises a premanufactured LED package which has been immersed in an index matching, or near index matching material by either molding around it the premanufactured LED package filling a space between the reflector body and premanufactured LED package, or by potting it into a premolded recess defined in a reflector body for receiving the premanufactured LED package.

42. The apparatus of claim 37 where the LED emitter, reflective surface and optical surface are each separate from each other, and are glued, potted, bonded, molded or assembled into a single unit.

43. The apparatus of claim 33 further comprising an optic fiber, the reflective surface being focused on the optic fiber so that the numerical aperture of the optic fiber and reflective surface are matched.

44. The apparatus of claim 43 where the optic fiber has an end surface and where the LED emitter, reflective surface and end surface of the optic fiber are integrated into a single body.

45. The apparatus of claim 43 further comprising a detector so that the apparatus is an optical transceiver.
